(19) United States
(12) Patent Application Publication
(10) Pub. No.: US 2025/0197737 A1
(43) Pub. Date: Jun. 19, 2025

(54) PROCESS FOR CONVERSION OF LIGNOCELLULOSIC MATERIAL TO AN ORGANIC LIQUEFACTION PRODUCT

(71) Applicant: RISE RESEARCH INSTITUTES OF SWEDEN AB, Borås (SE)

(72) Inventors: Werner Goldmann, Porvoo (FI); Noora Kaisalo, Porvoo (FI); Jani Kangas, Porvoo (FI); Pekka Nurmi, Porvoo (FI); Sami Toppinen, Porvoo (FI); Martin Hedberg, Södertälje (SE); Christian Bernlind, Södertälje (SE); Pia Appelqvist, Södertälje (SE)

(21) Appl. No.: 18/846,728

(22) PCT Filed: Mar. 17, 2023
(86) PCT No.: PCT/EP2023/056926

§ 371 Date: Sep. 13, 2024

(30) Foreign Application Priority Data
Mar. 17, 2022 (SE) 2250331-2

(51) Int. Cl. C10G 45/16; B01J 27/051; B01J 35/80; C10G 1/06; C10G 1/08; C10G 45/50

(52) U.S. Cl. CPC C10G 45/16; B01J 27/0515; B01J 35/80; C10G 1/06; C10G 1/086; C10G 45/50; B01J 2235/15; C10G 2300/1014

(57) ABSTRACT

Lignocellulosic starting materials can be converted into an organic liquefaction product in a hydroliquefaction process by subjecting a mixture of a lignocellulosic starting material, an amorphous and unsupported sulfided nickel-molybdenum catalyst and a co-feed, to not less than a stoichiometric amount of hydrogen, elevated pressure and a temperature within the range of from 270° C. and up to but not including 350° C.

### TECHNICAL FIELD

The present disclosure relates to a novel process to convert solid lignocellulosic raw materials to an organic liquefaction product.

### BACKGROUND

It is well known that thermochemical methods like pyrolysis and hydrothermal liquefaction (HTL) can depolymerize whole lignocellulosic biomass as well as lignocellulosic biomass fractionation products like kraft lignin and other renewable side streams from agriculture, forestry and the paper and pulping industry, often producing liquefied products collectively referred to as “bio-oils” or “bio-crude”. These can then be upgraded further using hydrotreatment and hydrocracking technologies more or less similar to the ones used to upgrade fossil crude oil and its distillates in oil refineries, to obtain mixtures of hydrocarbons which can be used as for instance transport fuel components.

Problems frequently encountered in thermochemical liquefaction (pyrolysis or HTL) of biomass include for example a relatively high oxygen content and the spontaneously reactive nature of the resulting depolymerized product mixture, containing, among other, different structural classes of molecules, such as reactive phenol derivatives in combination with aldehydes and ketones, which together cause more or less severe repolymerization during storage and/or heating. Other issues are for example the formation of char and a loss of high-volatility organic components, resulting in eventually lower carbon yields of hydrocarbon fuel components after upgrading than desirable.

The high content of water, in combination with the acidic nature of thermochemical bio-oils, creates a situation where these bio-oils are highly corrosive to standard construction materials used in refinery upgrading equipment. To illustrate with figures, pyrolytic conversion of lignocellulosic materials results in an oxygen content in the condensable fractions in the range of 20->40%. The same condensable fractions usually have pH-values of around 2-3 resulting from a high content of carboxylic acids and water. Overall, this means that the total oxygen and water content are not significantly lower than in the more stable non-depolymerized, dried but otherwise non-treated and considerably less acidic lignocellulosic biomass.

Summarizing the above, pyrolysis or HTL consequently, although the goal of obtaining a pumpable liquid bio-oil is often achieved, give bio-oils or biocrude products which are both corrosive and unstable for storage and heating due to issues with spontaneous repolymerization. Additionally, these products display poor or no miscibility with fossil or other renewable feedstocks of interest for facile and flexible co-processing in current standard refinery infrastructure. These properties are obviously problematic when developing practical robust full-scale processes for direct conversion of pyrolysis and/or HTL bio-oils both individually and through co-processing to hydrocarbon transport fuels and chemicals.

Typical conditions used in hydroprocessing are above 400° C. and pressures of about 180 bars [ref: Refining processes handbook, Surinder Parkash, 2003 Gulf Professional Publishing, Elsevier]. Also, prior art using NiMo catalyst to liquefy biomass (reference is made to Burton et al 1986, “Catalytic Hydroliquefaction of Lignocellulosic Biomass”, International Journal of Solar Energy) has been using temperature of 400° C. and tetralin as co-feed which is an efficient hydrogen donor solvent to facilitate liquefaction of biomass.

In summary, there is a demand for improved simple and robust processes, which can be applied to a commercially relevant selection of lignocellulosic raw materials and which are amenable for upscaling. These and other objectives will be apparent from the summary and the descriptions of certain embodiments below. It will be understood by those skilled in the art that one or more aspects can meet certain objectives, while one or more other aspects can meet certain other objectives.

### SUMMARY

The present disclosure makes available a new hydroliquefaction process which may be carried out at unexpectedly low temperatures. According to the present disclosure, this process for the conversion of lignocellulosic starting materials into an organic liquefaction product is characterized in that a lignocellulosic starting material, an amorphous and unsupported sulfided nickel-molybdenum catalyst, and a co-feed, are mixed, thereby obtaining a mixture, and that said mixture is subjected to not less than a stoichiometric amount of hydrogen, elevated pressure and a temperature within the range of from 270° C. and up to but not including 350° C., thereby producing an organic liquefaction product.

The process according to the present disclosure is a hydroliquefaction process, converting lignocellulosic biomass to an organic liquefaction product, which organic liquefaction product may for example be subsequently converted into fuels, or used in the production of chemicals. An advantage of the process according to the present disclosure is that it may be carried out at surprisingly low temperatures with surprisingly low solid residue, and thus has advantages in terms of decreased energy consumption in turn resulting in potential cost benefits. The ash free solid residue from the lignocellulosic starting materials in the present hydroliquefaction process is less than 15% by weight, preferably less than 10% by weight, most preferably less than 5% by weight.

A further advantage is that the organic liquefaction product, which may be an intermediate product intended for further conversion into one or more final products, has a low oxygen content which makes it a more thermally stable intermediate product and stable for storage. Furthermore, the product has low acidity, based on 31P-NMR product, and contains carboxylic acid groups<0.5 mmol/g or preferably <0.4 mmol/g, thus causing less risk for corrosion.

The organic liquefaction product additionally demonstrates improved physical properties, giving process benefits upon subsequent process steps, such as during pumping at ambient or at elevated temperatures. Furthermore, the intermediate organic liquefaction product obtained may, due to its low oxygen content, also be more easily integrated as a raw material in conventional refineries.

A further advantage is that the low oxygen content in the organic liquefaction product obtained by the process according to the present disclosure enables lower exotherms during complete hydrodeoxygenation to form hydrocarbon end products.

An important advantage with the catalyst being an unsupported carrier-free catalyst is that it can be added at different stages of the process, for example after the starting material is ground, and thus be intimately mixed with the starting material.

The temperature may be within the range of from 270° C. and 349° C. The temperature may be within the range of from 300° C. and up to but not including 350° C., preferably the temperature may be within the range of from 310° C. and up to but not including 350° C., more preferably the temperature may be within the range of from 320° C. and up to but not including 350° C.

The term “elevated pressure” refers to a pressure which is above atmospheric pressure.

The operating pressure may be within the range of from 50 to 300 bar. This may improve and accelerate the liquefaction process carried out at the temperature range of the present process. Preferably the pressure may be within the range of from 70 to 170 bars, more preferably from 80 to 150 bar.

The molar fraction of sulfur (S) in the amorphous and unsupported sulfided nickel-molybdenum catalyst with respect to the molar fraction of molybdenum (Mo) may be from 0.1 to 2.3. The amorphous and unsupported catalyst as disclosed herein has, surprisingly been found by the present inventors, to enable liquefaction of lignocellulosic starting material at temperatures which are significantly lower than in conventional hydrocracking processes. Typical hydrocracking temperatures for fossil feedstocks are from about 413° C. to 440° C. and at pressures of about 180 bars [ref: Refining processes handbook, Surinder Parkash, 2003 Gulf Professional Publishing, Elsevier].

In embodiments, the molar fraction of sulfur (S) is from 0.3 to 2.29. The molar fraction of sulfur may also be from 0.1 to 1.0, optionally from 0.3 to 0.99, e.g., from 0.5 to 0.95.

The molar fraction of nickel (Ni) in the amorphous and unsupported sulfided nickel-molybdenium catalyst with respect to the molar fraction of molybdenum (Mo) may be from 0.1 to 0.3. The molar fraction of nickel (Ni) in the amorphous and unsupported sulfided nickel-molybdenium catalyst with respect to the molar fraction of molybdenum (Mo) may be from 0.1 to 0.2.

Preferably said catalyst is introduced into the mixture of lignocellulosic starting materials in the form of a slurry of catalyst particles in a liquid co-feed, optionally the liquid co-feed is a pure liquid or a mixture of different liquid components. The liquid co-feed may be a hydrocarbon co-feed.

The catalyst may be substantially amorphous, as determined by X-ray powder diffraction analysis and optical microscopy using polarized light. Optionally, the catalyst is amorphous, as determined by X-ray powder diffraction analysis.

The distinction between amorphous and crystalline material, as determined by X-ray powder diffraction analysis, is that crystalline materials will give sharp peaks in the XRD pattern while amorphous material will not give rise to any sharp peaks. Hence, an amorphous catalyst, as determined by X-ray powder diffraction analysis, will not give rise to any sharp peaks in the XRD pattern.

The catalyst may have a particle size distribution with a median value within the range of from 1 to 200 μm, as determined by laser diffraction.

The mixture may be subjected to the elevated pressure and the temperature with the range according to the present disclosure of at least 30 minutes, optionally within a period of time within the range of from 30 minutes to 360 minutes.

The co-feed is a liquid co-feed and may be chosen from vegetable oils and fats, such tall oil and tall oil pitch, pyrolysis oil, HTL oil, animal fats, fatty acids, fossil or renewable liquid hydrocarbons, and/or a re-circulated or recycled product or a fraction of the product obtained in said process.

The co-feed may, but is not limited to, a mixture of a vegetable oil, and/or animal fats, and/or pure or mixed fossil or renewable hydrocarbons. The co-feed may for example be a paraffinic co-feed.

An advantage of the process according to the present disclosure is that various co-feeds may be used and that the process does not require usage of a hydrogen donor solvent having aromatic and/or cyclic structure as co-feed. The co-feed may for example be a paraffinic co-feed.

The co-feed may thus comprise a solvent other than a hydrogen donor solvent having an aromatic and/or cyclic structure.

The co-feed may optionally and furthermore be substantially free from tetralin, i.e. such that at least 99% of the co-feed is free from tetralin, or that at least 99.5% is free from tetralin. When the co-feed is substantially free from tetralin this means that no tetralin has been added as co-feed during the process, but a minor residue of tetralin may be formed during the process. Optionally, the co-feed is free from tetralin. The fact that the process may be carried out with a co-feed being substantially free from, or free from, tetralin enables the use of less expensive, conventional and readily accessible refinery feedstock or the use of recycled product or fraction of the product and thus provides a flexibility to the co-feed selection as co-feed is not required to have strong hydrogen donating capabilities to obtain high conversion of solid lignocellulosic starting material.

The lignocellulosic starting material may have a dry content of more than 50% by weight, preferably within the range of from 70 and 95% by weight, most preferably within the range of from 80 to 92% by weight.

The lignocellulosic starting material may be chosen from wood chips and/or saw dust; forestry residue chosen from bark, and/or roots; wood having been subjected to drying or a torrefaction process; lignocellulose from agriculture like for example straw from crops like oats, wheat, barley and rye, corn stover, grasses and herbs, forage crops, oat husks, rice husks, construction waste containing at least 50% by weight originating from lignocellulosic matter; and mixtures thereof.

The lignocellulosic starting material may not have been subjected to thermochemical treatment, such as pyrolysis or hydrothermal liquefaction, prior to being subjected to said process. Accordingly, a more simplified process can be achieved.

The organic liquefaction product may have a lower oxygen content than the feed, including the co-feed, optionally the organic liquefaction product may have at least 5% by weight lower oxygen content than the feed, including the co-feed, such as at least 10% by weight lower than the feed, i.e. than the lignocellulosic starting material and the co-feed.

The total feed may consist of from 5 to 90% by weight of solid biomass, preferably within the range of from 10 to 80% by weight of solid biomass. The total feed may consist of from 60 to 80% by weight of solid biomass or alternatively within the range of from 10 to 35% by weight of solid biomass. This implies that there is a liquid content of from 10% by weight, preferably up to 65% by weight, which may provide process advantages, such as a pumpable slurry.

The process may or may not be split into two or more hydroprocessing reactors having a flat or increasing temperature profile. The process may thus include at least second converting step, subsequent to the first hydroprocessing step.

In the second hydroprocessing reactor, the operating temperature may be with the range of from 270° C. to 450° C. Optionally the operating temperature in the second hydroprocessing reactor may be 350° C. or higher, such as within the range from 350° C. and 450° C.

Optionally, the operating temperature may be within the range of from 270° C. and up to but not including 350° C. in the second hydroprocessing reactor.

In a preferred embodiment the hydroprocessing is carried out in two or more reactors in a series, in which each subsequent reactor is operated at a higher temperature than the first reactor. Preferably the process is carried out with two reactors in a series, and the temperature of the first reactor is selected from the range of from 270° C. and up to but not including 350° C. and the temperature of the second reactor is selected from the range of from 340° C. to 400° C. Optionally, the process is carried out with three reactors in a series, and the temperature of the first reactor is selected from the range of from 270° C. and up to but not including 350° C., the temperature of the second reactor is selected from the range of from 340° C. to 400° C. and the temperature of the third reactor is selected from the range of from 380° C. to 400° C.

According to a further aspect, the present disclosure relates to an organic liquefaction product derived from a lignocellulosic biomass and obtained from the process as disclosed herein, the organic liquefaction product having an oxygen content of within the range of from 0.5% by weight and 35% by weight, as measured by elemental analysis.

It was found by the present inventors that the oxygen content of the lignocellulosic biomass, based on the dry content, was reduced by at least 40%, preferably at least 50% or most preferably at least 60% when liquefied to the organic liquefaction product, here including dodecane and THF soluble part. This may be seen in the Examples where the oxygen reduction of the organic liquefaction product, compared to the dry lignocellulosic biomass, was between 66% and 90%.

In an embodiment, the organic liquefaction product may form two phases: dodecane soluble phase and THF soluble phase respectively. The THF soluble phase may comprise 1-80% of the liquefied biomass, preferably 5-70%. THF soluble phase is characterized by having aromatic nature as characterized by 1H-NMR of 2-50 mol %. THF soluble phase can be also characterized by the phenolic OH content being 0.01-20 mmol/g, or preferably 0.1-10 mmol/g as measured by 31P-NMR.

### SHORT DESCRIPTION OF THE DRAWINGS

The aspects and embodiments will now be described, by way of example, with reference to the accompanying drawings, in which:

FIG. 1 shows a XRPD-diffractogram for catalyst prepared according to Example 1.

FIG. 2 shows a graph illustrating the particle size distribution of the catalyst obtained in Example 1.

FIG. 3 shows TGA-data for the organic liquid product phase of Example 2.

FIG. 4 shows TGA-data for the THF-soluble liquefaction phase of Example 2.

FIG. 5 shows TGA-data for the THF-soluble liquefaction phase of Example 3.

FIG. 6 shows TGA-data for the THF-soluble liquefaction phase of Example 3.

FIG. 7 shows particle size distribution for the catalyst according to Example 4.

FIG. 8 shows TGA-data for the organic liquid product phase of Example 5.

FIG. 9 shows TGA-data for the THF-soluble liquefaction phase of Example 5.

### DETAILED DESCRIPTION

When studying the detailed description, it is to be understood that the terminology employed herein is used for the purpose of describing particular embodiments only and is not intended to be limiting, since the scope of the present aspects and embodiments will be limited only by the appended claims and equivalents thereof.

It should be noted that, as used in this specification and the appended claims, the singular forms “a,” “an,” and “the” include plural referents unless the context clearly dictates otherwise.

The terms “lignocellulosic materials”, “lignocellulosic starting materials” and “lignocellulosic feed” are used herein to encompass all whole and non-fractionated lignocellulosic materials consisting substantially of cellulose, hemicellulose and lignin. Depending on geographic location, different materials are available, for example agricultural residues (e g corn stover, crop straw and bagasse), herbaceous crops (e g alfalfa, switchgrass), softwood and hardwood, short rotation woody crops, preheated and/or torrefied wood, forestry residues (bark as well as branches, roots and tops), and other waste (e g municipal and industrial waste containing whole lignocellulosic biomass like for example waste wood used in the construction industries and/or in packaging of goods). The present inventor has tested sawdust of pine having various dry substance contents, ground roots and branches of spruce, fresh spruce needles, fresh pine bark, and ground municipal waste containing wood, plastic, sand, metal and paint residues.

The terms “unsupported” and “carrier-free” are used to define that the catalyst material, for example the sulfided NiMo catalyst is not deposited on any solid carrier or support material.

The fact that the catalyst is “amorphous” intends to mean that it is amorphous over the entire surface thereof or at least over a major portion of the catalyst surface.

The organic liquefaction product obtained may be liquid from room temperature, and up to 500° C. The organic liquefaction product may comprise one or more organic liquid phases.

The term “solid residue” here refers to remaining solids which are separated from the organic liquefaction products after hydroliquefaction of lignocellulose as exemplified in the experimental examples below.

According to the present disclosure, this process for the conversion of lignocellulosic starting materials into an organic liquefaction product is characterized in that a lignocellulosic starting material, either from a single source or from a mixture of relevant starting materials, an amorphous and unsupported sulfided nickel-molybdenum catalyst and a co-feed, is mixed and subjected to not less than a stoichiometric amount of hydrogen, elevated pressure and a temperature within the range of from 270° C. and up to but not including 350° C., producing an organic liquefaction product. The temperature may be within the range of from 270° C. to 349° C.

Preferably said catalyst is introduced into the mixture of lignocellulosic starting materials in the form of a slurry of catalyst particles in a co-feed.

A co-feed is present in the process and the co-feed may be chosen from vegetable oils and fats, such as tall oil, tall oil pitch, pyrolysis oil, HTL oil, animal fats, fatty acids, fossil or renewable liquid hydrocarbons, and/or a re-circulated or recycled product or a fraction of the product obtained in said process.

The lignocellulosic starting material may have a dry content of more than 50% by weight, preferably within the range of from 70 and 95% by weight, most preferably within the range of from 80 to 92% by weight.

The lignocellulosic starting material may be chosen from wood chips and/or saw dust; forestry residue chosen from bark, and/or roots; wood having been subjected to drying or a torrefaction process; lignocellulose from agriculture like for example straw from crops like oats, wheat, barley and rye, corn stover, grasses and herbs, forage crops, oat husks, rice husks, construction waste containing at least 50% by weight originating from lignocellulosic matter; and mixtures thereof.

Regarding material that has been subjected to drying or a torrefaction process, it is underlined that torrefaction is here considered to be merely a drying step, i.e. the removal of moisture, and not a proper thermochemical process.

According to another embodiment, also freely combinable with the above aspect and embodiments, the lignocellulosic starting material has not been subjected to thermochemical treatment, such as pyrolysis or hydrothermal liquefaction, prior to being subjected to said process.

According to yet another embodiment, also freely combinable with the above aspect and embodiments, the operating pressure may be in an interval of 50-300 bar. When the process is operated in a batch-wise fashion, the initial pressure is set according to the available headspace volume and in a way which secures a stoichiometric excess of hydrogen, for instance set at an initial pressure at ambient temperature of 120 bar and allowed to increase and stabilize at 150-300 bar, preferably 250 bar. When the process is operated in a continuous fashion, the pressure is preferably set at 70-170 bar, most preferably 80-150 bar.

The process according to the present disclosure may performed in batch, semi-batch, or continuous mode of operation.

The lignocellulosic starting material may be subjected to mechanical pretreatment to simplify the material handling and to increase the surface to volume ratio. Suitable pretreatment operations include milling, chipping and grinding. Starting material of various particle sizes are suitable, such as particle sizes being <25 mm, preferably <5 mm.

The mixture of lignocellulosic starting material, a catalyst and liquid co-feed/-s is fed into a reaction zone and be subjected to increased temperature and pressure, for example a temperature within the range of from 270° C. and up to but not including 350° C. and a pressure in the interval of 50-300 bar, preferably about 140 bar. The rate at which the material is transported through the reactor, as well as the temperature and pressure can be adjusted depending on the properties of the starting material and the desired products.

The reaction time, under which the mixture is subjected to a temperature within the range of from 270° C. and up to but not including 350° C. and a pressure in the interval of 50-300 bar may be from 30 min, optionally within a range of from 30 min to 360 min.

It is currently held that a pressure in the range of 50-200 bar (5-20 MPa) and a temperature within the range of from 270° C. and up to but not including 350° C. is most suitable for hydroliquefaction and partial hydrodeoxygenation of lignocellulosic raw materials using the present or similar carrier-free catalyst.

A person skilled in the art is well familiar with unit operations such as mixing, transport, gas-liquid, liquid-liquid and liquid-solid separation and the equipment for performing the same, as well as the terminology used to describe and quantify properties used in conjunction with these unit operations such as heat transfer, see for example textbooks such as Unit Operations of Chemical Engineering, Warren L. McCabe et al., 7th Ed., McGraw-Hill Professional, 2004.

The present disclosure provides a process which converts a lignocellulosic biomass to an organic liquefaction product, such as an intermediate bio-oil or biocrude, which may be used as transportation fuels, such as gasoline, jet, diesel or marine fuels after blending or subsequent processing. Alternatively, the organic liquefaction product obtained may be used in petrochemicals industry, either as e.g., steam cracker feedstock or as solvent. In some conditions phenolics (phenol, creosol etc.) can be recovered from the organic liquefaction product and be used as feedstocks in the chemical and polymer industry.

### EXAMPLES

### Analytical Methods

Determination of hydroxyl numbers analyzing amounts of hydroxyl groups belonging to aliphatic alcohols (aliphatic OH), phenols (aromatic OH) and OH-groups of carboxylic acids, was performed by ³¹P-NMR on a Bruker Avance 500 UltraShield NMR spectrometer using methodology described for instance in L. Akim et al. Holzforschung 2001, 55, 386-390. ¹H-NMR was used to characterize relative amounts of protons being part of aromatic, aliphatic, ether/alcohol, aldehyde, ketone, carboxylic acid and olefin functionalities of the obtained product mixtures.

Boiling point ranges were determined using thermogravimetric analysis on a Mettler-Toledo TGA/SDTA851e instrument.

Particle size distribution was performed using a Malvern Mastersizer 2000 laser diffractor. Samples analyzed were dispersed in dodecane before measurements and measurements were performed as follows: The instrument slurry tank and measurement cell were filled with 160 mL dodecane and air was evacuated by stopping/starting the stirring. The sample vial was vortexed for 1 min prior to sample extraction. A 20-50 μL sample was taken out by pipette in several smaller (5-10 μL) portions and transferred to the measurement cell. After 1 min of circulation the measurement was started. After the first measurement the particle slurry was subjected to ultrasound treatment inside the Malvern instrument for up to 4 min. The second measurement was performed after the sonication and evacuation of air.

X-ray powder diffraction analysis (XRPD) was performed on a PANalytical X′Pert PRO spectrometer.

### Example 1. Preparation of Nickel-Molybdenum Slurry Catalyst

To a 1.8 L pressure proof stainless steel vessel was added 40 g of molybdenum trioxide, 59.7 g of a 20% (w/w) aqueous solution of ammonium sulfide and 122 g of ultra-pure water. After flushing with nitrogen the reactor was pressurized to 26 bar with hydrogen. The reactor had been equipped with a blade impeller which was set to a tip speed of 4-5 m/s and the reactor temperature was adjusted to 64-68° C. and soaked at this temperature for 4 hours. After cooling to 40° C. and de-pressurization the headspace to atmospheric pressure 301 g of dodecane was added followed by 34.1 g of a 36.2% (w/w) nickel (II) sulfate hexa-/heptahydrate solution. The latter was added during 30 min via a syringe pump at the maintained stirrer speed. The reactor was pressurized to 18 bar using hydrogen gas and was heated to 210° C. for 6 hours before being allowed to soak at this temperature for an additional hour. The reactor was cooled to 40° C. during 2 hours after which the pressure was released and the reactor was equipped with a water-cooled distillation head. A stream of nitrogen gas ballast was added to the reactor at approximately 2 L/min and the reactor temperature was ramped up at approximately 2K/min. The procedure was continued until the water fraction was distilled off followed by distillation of approximately 50% of the dodecane. After cooling to room temperature, the reactor content, consisting of an activated nickel-molybdenum slurry catalyst in dodecane, was poured into a glass beaker. The solid content of the slurry was found to be 23.4% (w/w). The empirical molecular formula according to the procedure above was MoNi_{0.163}S_{0.722} with correction for assay and purities/assays for the reagents. Elemental analysis gave MoNi_{0.171}S_{0.860}.

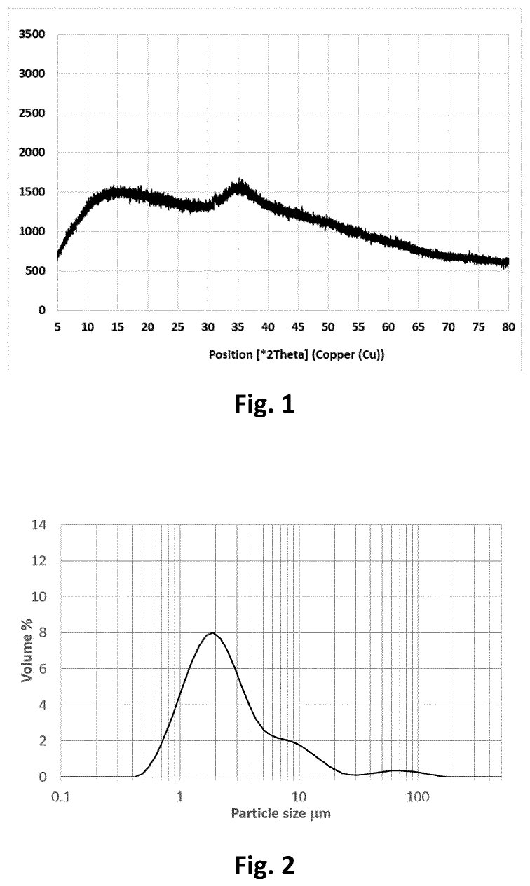

The XRPD-diffractogram for catalyst prepared according to Example 1 shown in FIG. 1 below shows no XRPD peaks that would suggest any degree of crystallinity and the conclusion is that the catalyst according to Example 1 is amorphous.

FIG. 1 illustrates a XRPD-diffractogram for catalyst prepared according to Example 1.

The particle size distribution data measured as described above are shown in FIG. 2. The results indicate a median particle size of 2 μm.

FIG. 2 illustrates the particle size distribution of Example 1. d(0.1): 1 μm, d(0.5): 2 μm, d(0.9) 9 μm (4 min sonication).

### Example 2

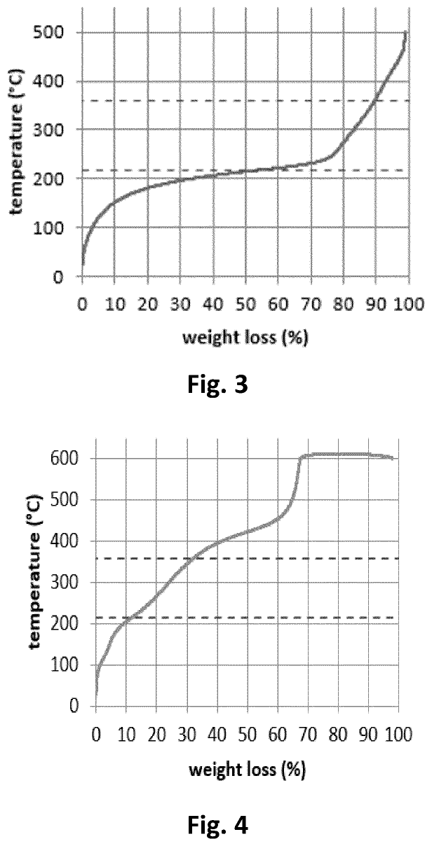

Saw dust <0.28 mm (10.01 g, dry matter content 91.5% w/w), and a catalyst slurry prepared according to Example 1 (3.21 g, assay 23.4% w/w in dodecane) were mixed at room temperature in a high-pressure reactor. An inert nitrogen atmosphere was established using vacuum—nitrogen cycles before the reactor was pressurized with hydrogen (119 bar). The reaction mixture was heated to 320° C. and kept at that temperature for 120 min. The maximum working pressure during reaction was 239 bars. After cooling, de-pressurization and establishment of an inert atmosphere by vacuum—nitrogen cycles, the reactor contents were poured into a centrifuge vial and centrifuged at 2.9×10-3 G for 20 minutes. An organic liquid phase, an aqueous phase, and a solid residue phase were separated. The solid residue, the reactor, lid and stirrer were washed consecutively using two portions of n-pentane (2×30 mL) and three 30 mL-portions of tetrahydrofuran (THF). After each wash the mixtures were centrifuged and separated. The n-pentane wash phases were pooled in one separate vessel and THF-wash phases were pooled in another separate vessel, after which solvents (n-pentane and THF) were evaporated. After complete work up which for the pentane and THF-phases including drying, the following products were isolated: an organic liquid phase which was pooled with the content of the n-pentane wash phase (1.77 g in total, 15% yield w/w calculated on the whole feed including dodecane), 2.6 g of an aqueous phase, 4.53 g of a THF-soluble liquefaction phase and 0.901 g of a solid residue. ¹H- and ³¹P-NMR-data for the organic liquid phase are found below in Table 1 and Table 2 and TGA-data are shown in FIG. 3. ¹H- and ³¹P-NMR-data for the THF-soluble liquefaction phase are found below in Table 3 and Table 4 and TGA-data are shown in FIG. 4. The NMR results indicate that the THF-soluble liquefaction phase has a higher oxygen content, something which is confirmed by the elemental analysis data below. The amount of unconverted solid material as calculated on dry biomass was, despite the lower reaction temperature than typically used in hydroprocessing, only 1.6% w/w. Taking into account that the sawdust ash content was 0.6%, the amount of solid product is remarkably low.

TGA-data for the THF-soluble liquefaction phase show that 65% w/w of the THF-soluble liquefaction phase is volatile below 500° C. Thus, the total organic product yield on a dry biomass basis is 25% w/w. The yield calculation on dry biomass basis does not include dodecane which was added to the reactor with the catalyst (2.46 g). It is assumed that dodecane is not converted during the process and can therefore be subtracted from the organic product amount. The boiling point distribution for the whole organic product is presented in Table 5 below.

Elemental analysis data for the organic liquid phase: C 82.3%, H 13.5%, N 0.2%, S 0.0%, O 2.8%, other 1.1%.

Elemental analysis data for the THF-soluble liquefaction phase: C 77.8%, H 8.1%, N 0.62%, S 0.0%, O 12.8%, other 0.0%.

TABLE 1
below shows ¹H-NMR (CDCl₃) results for the organic liquid phase of
Example 2 (normalized integrals).

| Example 2: ¹H-NMR signals | ppm | Integral |
|---|---|---|
| Carboxylic acid H (COOH) and | 12-9 | 0 |
| aldehyde H (CHO) | | |
| Aromatic H | 9-6.2 | 2.0 |
| Olefin H | 6.2-4.5 | 0.3 |
| Aliphatic alcohol H, —CHOH or | 4.5-3.3 | 0.5 |
| aliphatic ether —CHOR | | |
| Aliphatic H | 3.3-0 | 97.2 |

TABLE 2
below shows Hydroxyl numbers measured by ³¹P-NMR for the organic
liquid phase of Example 2.

| | Aliphatic OH | Aromatic OH | |
|---|---|---|---|
| | (mmol/g) | (mmol/g) | Carboxylic acid |
| Example 3 | 0.37 | 0.10 | Not detected |

FIG. 3 shows TGA-data for the organic liquid product phase of Example 2. The dotted lines indicate boiling point range of diesel.

TABLE 3
below shows ¹H-NMR (DMSO-d6) results for Example 2, THF soluble
liquefaction phase (normalized integrals).

| Example 2: ¹H-NMR signals | ppm | Integral |
|---|---|---|
| Carboxylic acid H (COOH) and | 12-9 | 1.3 |
| aldehyde H (CHO) and phenol (OH) | | |
| Aromatic H | 9-6.2 | 10.3 |
| Olefin H | 6.2-4.5 | 3.0 |
| Aliphatic alcohol H, —CHOH or | 4.5-3.3 | 10.9 |
| aliphatic ether —CHOR | | |
| Aliphatic H | 3.3-0 | 74.5 |

TABLE 4
below shows hydroxyl numbers measured by ³¹P-NMR for the
THF-soluble liquefaction phase of Example 2.

| | Aliphatic OH | Aromatic OH | |
|---|---|---|---|
| | (mmol/g) | (mmol/g) | Carboxylic acid |
| Example 2 | 0.59 | 1.72 | 0.09 |

FIG. 4 shows TGA-data for the THF-soluble liquefaction phase of Example 2, the dotted lines indicate boiling point range of diesel.

TABLE 5
below shows boiling point distribution for the total organic product.

| | | Mass fraction of combined liquid phase, |
|---|---|---|
| Boiling point region | | THF soluble phase and catalyst solvent |
| <180° | C. | 10% |
| 180-360° | C. | 38% |
| 360-500° | C. | 26% |
| >500° | C. | 24% |

### Example 3

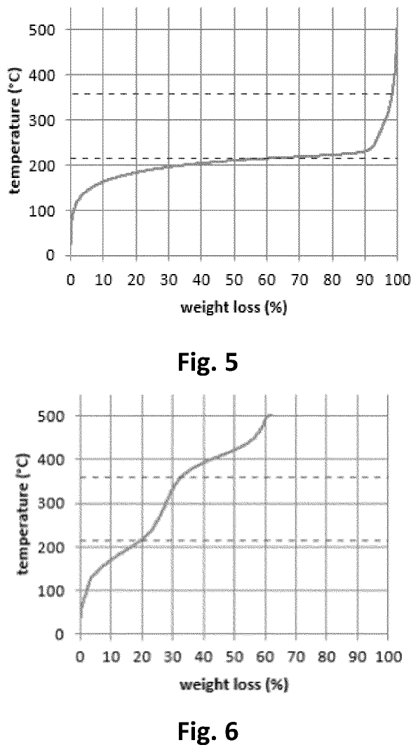

Saw dust<0.28 mm (10.17 g, dry matter content 91.5% w/w), and a catalyst slurry prepared according to Example 1 (3.56 g, 23.4% w/w in dodecane) were mixed at room temperature in a high-pressure reactor. An inert nitrogen atmosphere was established using vacuum—nitrogen cycles before the reactor was pressurized with hydrogen (118 bar). The reaction mixture was heated to 270° C. and kept at that temperature for 120 min. The maximum working pressure during reaction was 235 bars. After using the work up procedure described in Example 2, 1.67 g of a dark amber organic liquid phase (14% yield w/w calculated on the whole feed including dodecane), 1.14 g of an aqueous phase, 6.02 g of a THF-soluble liquefaction phase (50% yield) and 1.14 g of a solid residue were isolated. ¹H- and ³¹P-NMR-data for the organic liquid phase is found below in Table 6 and Table 7 and TGA-data are shown in FIG. 5. ¹H- and ³¹P-NMR-data for the THF-soluble liquefaction phase are found below in Table 8 and Table 9 and TGA-data are shown in FIG. 6. The NMR results indicate that the THF-soluble liquefaction phase has a higher oxygen content, something which is confirmed by the elemental analysis data below. The amount of unconverted solid material as calculated on dry biomass was, despite the considerably lower reaction temperature than typically used in hydroprocessing, only 3.4% w/w. Taking into account that the sawdust ash content was 0.6%, the amount of solid product is low.

TGA-data for the THF-soluble liquefaction phase show that 61% of the THF-soluble liquefaction phase is volatile below 500° C. Thus, the total organic product yield on a dry biomass basis is 28% w/w. The yield calculation on dry biomass basis does not include dodecane which was added to the reactor with the catalyst (2.46 g). It is assumed that dodecane is not converted during the process and can therefore be subtracted from the organic product amount. The boiling point distribution for the total organic product is presented in Table 10 below.

Elemental analysis data for the organic liquid phase: C 81.9%, H 14.4%, N 0.0%, S 0.0%, O 1.9%, other 1.7%.

Elemental analysis data for the THF-soluble liquefaction phase: C 69.9%, H 7.7%, N 0.54%, S 0.04%, O 20.6%, other 1.23%.

TABLE 6
below shows ¹H-NMR (CDCl₃) results for the organic liquid phase of
Example 3 (normalized integrals).

| Example 3: ¹H-NMR signals | ppm | Integral |
|---|---|---|
| Carboxylic acid H (COOH) and | 12-9 | 0 |
| aldehyde H (CHO) | | |
| Aromatic H | 9-6.2 | 0.5 |
| Olefin H | 6.2-4.5 | 0.2 |
| Aliphatic alcohol H, —CHOH or | 4.5-3.3 | 0.4 |
| aliphatic ether —CHOR | | |
| Aliphatic H | 3.3-0 | 98.9 |

TABLE 7
below shows hydroxyl numbers measured by ³¹P-NMR for the organic
liquid phase of Example 3.

| | Aliphatic OH | Aromatic OH | |
|---|---|---|---|
| | (mmol/g) | (mmol/g) | Carboxylic acid |
| Example 3 | 0.1 | 0.1 | 0.1 |

FIG. 5 shows TGA-data for the organic liquid product phase of Example 3. The dotted lines indicate boiling point range of diesel.

TABLE 8
below shows ¹H-NMR (DMSO-d6) results for Example 3,
THF-soluble liquefaction phase (normalized integrals).

| Example 3: ¹H-NMR signals | ppm | Integral |
|---|---|---|
| Carboxylic acid H (COOH) and | 12-9 | 0.9 |
| aldehyde H (CHO) and phenol (OH) | | |
| Aromatic H | 9-6.2 | 9.0 |
| Olefin H | 6.2-4.5 | 2.3 |
| Aliphatic alcohol H, —CHOH or | 4.5-3.3 | 17.0 |
| aliphatic ether —CHOR | | |
| Aliphatic H | 3.3-0 | 70.8 |

TABLE 9
below shows hydroxyl numbers measured by³¹P-NMR for the
THF-soluble liquefaction phase of Example 3.

| | Aliphatic OH | Aromatic OH | |
|---|---|---|---|
| | (mmol/g) | (mmol/g) | Carboxylic acid |
| Example 3 | 0.66 | 2.01 | 0.33 |

FIG. 6 shows TGA-data for the THF-soluble liquefaction phase of Example 3. The dotted lines indicate boiling point range of diesel.

TABLE 10
below shows boiling point distribution for the total organic product.

| | | Mass fraction of combined liquid phase, |
|---|---|---|
| Boiling point region | | THF soluble phase and catalyst solvent |
| <180° | C. | 13% |
| 180-360° | C. | 34% |
| 360-500° | C. | 22% |
| >500° | C. | 31% |

### Example 4. Preparation of nickel-molybdenum Slurry Catalyst—Second Example

Molybdenum (VI) oxide (250 g, 1.74 mol), deionized water (760 mL) and ammonium sulfide (20% w/w in water, 400 mL, 1.26 mol) were added to a two gallon Parr high pressure reactor equipped with a pitch blade mechanical agitator. The reactor was closed and leak tested using nitrogen to pressurize the reactor vessel. Formier gas (5% w/w of hydrogen in nitrogen) was added continuously in a controlled manner using a capillary outlet tuned to set the system pressure to 50 bar system pressure. Gas coming out from the reactor was bubbled through a hydrogen peroxide scrubber to trap and oxidize the sulfur-containing off gases. The reaction mixture was heated at 68° C. for 4 h before cooling to 38° C. over 1 h, keeping the mixture at 38° C. for 2 h. Nickel (II) sulfate mixed hexa and heptahydrate (86.9 g, 0.284 mol) dissolved in water (0.24 L) was added to the reactor followed by the addition of dodecane (2.5 L).

The reaction mixture was then heated to 210° C. during 6 h and was then kept at this temperature for 1 h before being allowed to cool to room temperature which took 3.5 h. The Formier gas flow and pressure was kept at 50 bar throughout the heating and cooling periods bubbling it through the scrubber solution of hydrogen peroxide. The Formier gas flow was turned off and water was distilled off from the reactor together with parts of the dodecane at a jacket temperature of 190° C. The distillation went on for about 1.5 h before allowing the reactor to cool down over night.

The reactor was opened and catalyst particles sitting on the reactor vessel walls were scraped down into the liquid slurry phase. Dimethyl disulphide (DMDS, 168 mL, 1.88 mol) was added, and the reactor was closed and leak tested. The reaction mixture was heated to 320° C. during 1.5 h and then kept at this temperature for 4 h before cooling to room temperature over night. The reactor was then flushed with nitrogen leading the off gases to the hydrogen peroxide scrubber. The black slurry obtained was transferred to a container and homogenized using a mechanical pitch blade agitator before taking four samples to determine the slurry assay. The average assay from four samples was 18.25% w/w of NiMoS-catalyst in dodecane and the total weight of the obtained slurry was 1.558 kg.

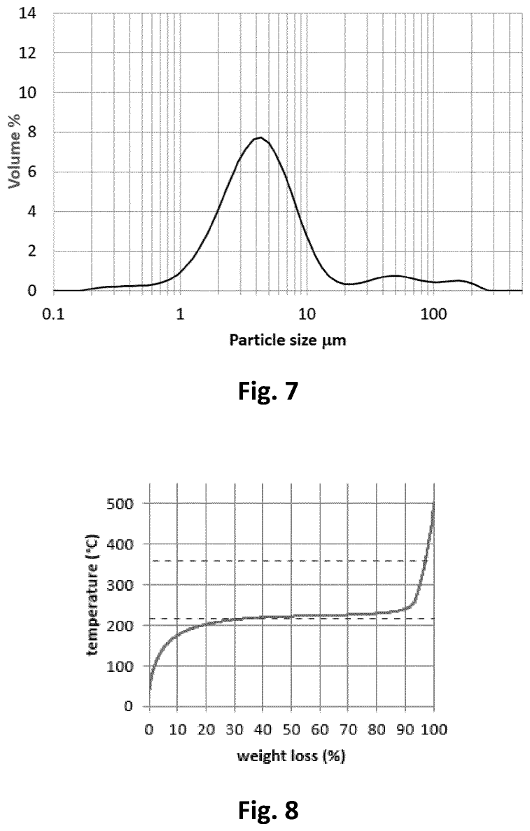

Analysis of the particle size distribution for this catalyst batch was performed as described for the catalyst in Example 1 above using a Malvern laser diffractometer. Data shown in FIG. 7 below indicate a median particle size of 4 μm for the catalyst made according to Example 4.

FIG. 7 shows particle size distribution for the NiMoS-catalyst according to Example 4.

### Example 5

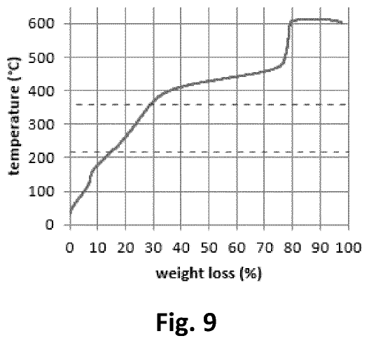

Saw dust having a particle size distribution <0.28 mm (20.0 g, dry matter content 91.5% w/w), a catalyst slurry prepared according to Example 4 (4.00 g, 18.25% w/w in dodecane) and dodecane (35.3 mL) were mixed at room temperature in a high-pressure reactor. An inert nitrogen atmosphere was established using vacuum—nitrogen cycles before the reactor was pressurized with hydrogen (140 bar). The reaction mixture was heated to 340° C. and kept at that temperature for 120 min. The maximum working pressure during reaction was 270 bars. After using the work up procedure described in Example 2, 33.8 g of a dark amber organic liquid phase (67% yield w/w calculated on the whole feed including dodecane), 7.06 g of an aqueous phase, 3.62 g of a THF-soluble liquefaction phase (7.2% yield) and 1.02 g of a solid residue were isolated. ¹H- and ³¹P-NMR-data for the organic liquid phase are found below in Table 11 and Table 12 and TGA-data are shown in FIG. 8. ¹H- and ³¹P-NMR-data for the THF-soluble liquefaction phase are found below in Table 13 and Table 14 and TGA-data are shown in FIG. 9. The NMR results indicate that the THF-soluble liquefaction phase has a higher oxygen content, something which is confirmed by the elemental analysis data below. The amount of unconverted solid material as calculated on dry biomass was 1.6% w/w.

TGA-data for the THF-soluble liquefaction phase show that 78% of the THF-soluble liquefaction phase is volatile below 500° C. Thus, the total organic product yield on a dry biomass basis is 37% w/w. The yield calculation on dry biomass basis does not include dodecane which was added to the reactor. It is assumed that dodecane is not converted during the process and can therefore be subtracted from the organic product amount. The boiling point distribution for the total organic product is presented in Table 15 below.

Elemental analysis data for the organic liquid phase: C 84.3%, H 15.0%, N 0.0%, S 0.0%, O 1.08%, other −0.32%.

Elemental analysis data for the THF-soluble liquefaction phase: C 79.5%, H 8.8%, N 0.39%, S 0.04%, O 9.4%, other 1.9%.

TABLE 11
below shows ¹H-NMR (CDCl₃) results for the organic liquid
phase of Example 5 (normalized integrals).

| Example 5: ¹H-NMR signals | ppm | Integral |
|---|---|---|
| Carboxylic acid H (COOH) and | 12-9 | 0 |
| aldehyde H (CHO) | | |
| Aromatic H | 9-6.2 | 0.64 |
| Olefin H | 6.2-4.5 | 0.2 |
| Aliphatic alcohol H, —CHOH or | 4.5-3.3 | 0.36 |
| aliphatic ether —CHOR | | |
| Aliphatic H | 3.3-0 | 98.8 |

TABLE 12
below shows Hydroxyl numbers measured by ³¹P-NMR for the
organic liquid phase of Example 5.

| | Aliphatic OH | Aromatic OH | |
|---|---|---|---|
| | (mmol/g) | (mmol/g) | Carboxylic acid |
| Example 5 | 0.22 | 0.17 | 0.02 |

FIG. 8 shows TGA-data for the organic liquid product phase of Example 5. The dotted lines indicate boiling point range of diesel.

TABLE 13
below shows ¹H-NMR (DMSO-d6) results for Example 5,
THF-soluble liquefaction phase (normalized integrals).

| Example 5: ¹H-NMR signals | ppm | Integral |
|---|---|---|
| Carboxylic acid H (COOH) and | 12-9 | 1.6 |
| aldehyde H (CHO) and phenol (OH) | | |
| Aromatic H | 9-6.2 | 12.8 |
| Olefin H | 6.2-4.5 | 0 |
| Aliphatic alcohol H, —CHOH or | 4.5-3.3 | 5.3 |
| aliphatic ether —CHOR | | |
| Aliphatic H | 3.3-0 | 80.2 |

TABLE 14
below shows hydroxyl numbers measured by ³¹P-NMR for the
THF-soluble liquefaction phase of Example 5.

| | Aliphatic OH | Aromatic OH | |
|---|---|---|---|
| | (mmol/g) | (mmol/g) | Carboxylic acid |
| Example 5 | 0.39 | 2.82 | 0.1 |

FIG. 9 shows TGA-data for the THF-soluble liquefaction phase of Example 5. The dotted lines indicate boiling point range of diesel.

TABLE 15
below shows boiling point distribution for the total organic
product of Example 5.

| | | Mass fraction of combined liquid phase, |
|---|---|---|
| Boiling point region | | THF soluble phase and catalyst solvent |
| <180° | C. | 15% |
| 180-360° | C. | 75% |
| 360-500° | C. | 8% |
| >500° | C. | 2% |

1. A process for the conversion of lignocellulosic starting materials into an organic liquefaction product characterized in that in a first hydroprocessing step lignocellulosic starting material, an amorphous and unsupported sulfided nickel-molybdenum catalyst and a co-feed, are mixed, thereby obtaining a mixture, and said mixture being subjected to not less than a stoichiometric amount of hydrogen, an elevated pressure and a temperature within the range from 270° C. and up to but not including 350° C., thereby producing an organic liquefaction product.

2. The process according to claim 1, wherein the molar fraction of sulfur (S) in said amorphous and unsupported sulfided nickel-molybdenum catalyst with respect to the molar fraction of molybdenum (Mo) is from 0.1 to 2.3.

3. The process according to claim 1, wherein the molar fraction of nickel (Ni) in said amorphous and unsupported sulfided nickel-molybdenum catalyst with respect to the molar fraction of molybdenum (Mo) is from 0.1 to 0.3.

4. The process according to claim 1, wherein said catalyst is introduced into said mixture of lignocellulosic starting materials in the form of a slurry of catalyst particles in a liquid co-feed.

5. The process according to claim 4, wherein said liquid co-feed is chosen from vegetable oils and fats, tall oil, tall oil pitch, animal fats, fatty acids, pyrolysis oil, HTL oil, fossil or renewable liquid hydrocarbons, and/or a re-circulated product or fraction of product obtained in said process, and any mixtures thereof.

6. The process according to claim 5, wherein said co-feed is a mixture of a vegetable oil and/or animal fats and/or a fossil or renewable hydrocarbon.

7. The process according to claim 1, wherein the total feed consists of from 5% to 90% by weight of solid biomass, preferably within the range of from 10% to 80% by weight of solid biomass.

8. The process according to claim 7, wherein the total feed consists of from 60% to 80% by weight of solid biomass.

9. The process according to claim 7, wherein the total feed consists of from 10% to 35% by weight of solid biomass.

10. The process according to claim 1, wherein the mixture is subjected to a pressure within the range from 50 bar to 300 bar.

11. The process according to claim 1, wherein said organic liquefaction product has a lower oxygen content than the feed, including the co-feed, optionally the organic liquefaction product has at least 5% by weight lower oxygen content than the feed, including the co-feed.

12. The process according to claim 1, wherein said lignocellulosic starting material has a dry content of more than 50% by weight.

13. The process according to claim 1, wherein said lignocellulosic starting material is chosen from wood chips and/or saw dust; forestry residue chosen from bark, and/or roots, and/or branches; wood having been subjected to drying or a torrefaction process; lignocellulose from agriculture like for example straw from crops like oats, wheat, barley and rye, corn stover, grasses and herbs, forage crops, oat husks, rice husks, construction waste containing at least 50% by weight originating from lignocellulosic matter; and mixtures thereof.

14. The process according to claim 1, wherein said lignocellulosic starting material has not been subjected to thermochemical treatment, such as pyrolysis or hydrothermal liquefaction, prior to being subjected to said process.

15. The process according to claim 1, wherein said process may or may not be split into two or more hydroprocessing reactors having a flat or increasing temperature profile.

16. The process according to claim 1, wherein said catalyst is substantially amorphous as determined by X-ray powder diffraction analysis and optical microscopy using polarized light.

17. The process according to claim 1, wherein said catalyst has a particle size distribution with a median value within the range of 1-200 μm, as determined by laser diffraction.

18. An organic liquefaction product obtained by the process according to claim 1, the organic liquefaction product having an oxygen content within a range of from 0.5% by weight than 35% by weight, as measured by elemental analysis.
